(19) United States
(12) Patent Application Publication
(10) Pub. No.: US 2003/0120613 A1
(43) Pub. Date: Jun. 26, 2003

(54) Customizing objects and materials with digital identifiers

(76) Inventor: Jayant Neogi, Aloha, OR (US)

Correspondence Address: CHRISTIE, PARKER & HALE, LLP, 350 WEST COLORADO BOULEVARD, SUITE 500, PASADENA, CA, 91105, US

(21) Appl. No.: 10/343,257

(22) PCT Filed: Jul. 28, 2001
(86) PCT No.: PCT/US01/23693

(51) Int. Cl. G06F 17/60

(52) U.S. Cl. 705/75

(57) ABSTRACT

A method and apparatus for marking, identifying, customizing, and tracking objects and mined materials such as gemstones and precious metals. An initial digital identifier, such as a matrix (100), is encoded with source data. The initial digital identifier is decoded, and the source data is recorded to a database (1520). The gemstone passes from between parties through one or more transactions. Transactional data is also written to the database. After a series of transactions, the rough gemstone (1600) is cut into one or more finished gemstones (1610, 1620). The quality attributes of the polished gemstones are analyzed and recorded to the database. Based on the database information, a unique identifier is generated for each polished gemstone. The unique identifier and the database data are encoded into a digital identifier such as a matrix. Additionally, an owner may input data which is encoded into the same or a separate matrix. The matrix is then applied to the gemstone. With a matrix decoder, an owner may retrieve various types of information from the matrix, such as gemstone source data, the transaction history, quality attributes, and owner-specific data such as video, audio, photographs, images, and text.

### FIELD OF THE INVENTION

The present invention relates to marking, identifying, tracking, and customizing mined objects such as, for example, gemstones precious metals, and similar objects. More particularly, the present invention relates to marking, identifying, tracking, and customizing such objects with a digital identifier, representation, code or marking.

### BACKGROUND OF THE INVENTION

Objects such as mined objects, gemstones, and precious metals are highly valued commodities in both rough (i.e. uncut or unpolished) and finished form. These objects can be easily transported, sequestered and exchanged. A method and apparatus to secure a gemstone and document information such as its genealogy, origin, chain of custody, quality attributes, ownership, and other types of information, which does not degrade the gemstone by accepted standards, would be very useful and desirable.

A discussion of the geo-political issues concerning the critical need to document the chain of custody and origin of “Conflict Diamonds,” i.e., diamonds which have been mined or otherwise obtained by insurgency movements to finance the purchase of arms and supplies, may be found in a publication entitled “Conflict Diamonds: Possibilities for the Identification, Certification and Control of Diamonds,” published in June 2000 by the organization Global Witness. This article describes the structure of the international diamond market, the difficulties which exist in determining the origin of diamonds and the currently known technology for the identification of diamonds.

Although certain identification methods are known, they generally require an expert examination of the diamond in question. Such an examination typically involves considerable time and expertise and may yield inconclusive results. A fully satisfactorily, reliable, relatively tamper-proof, cost-effective method, which does not degrade the diamond by accepted standards, is not currently known for marking rough gemstones.

By way of example, viable gemstone identification and tracking systems, to become accepted by a large part of the industry, should accomplish the following objectives:

a. MINIMAL COST: The coding or identification of the rough gemstones, on a per stone basis, should be relatively inexpensive.

b. SPEED: Because grading occurs downstream from the extraction of the gemstones, rough extracted gemstones, as well as finished cut gemstones, should be encoded. Thus, a coding process that is time efficient should be used to handle the volume of rough gemstones which are mined.

c. ACCOMMODATE SURFACE IRREGULARITIES: Unlike finished stones, which have been cut to somewhat uniform and recognizable shapes, rough gemstones arrive in a plethora of irregular shapes and sizes. A marking and tracking system should tolerate these variables.

d. SIMPLICITY: The sheer volume of rough gemstones extracted from any location may require multiple coding sites or protocols. It is preferable that the coding or identification system be easy to set-up and operate. It is preferable to read gemstone codes and be able to obtain the desired gemstone information from the digital code itself.

e. THOROUGH DIAMOND DOCUMENTATION: Identification and tracking systems should be able to accommodate transactional information from various sources, e.g., mining locations, distributors, cutters, dealers, etc. As a result, a complete history of a gemstone from mine to showroom can be tracked and accessed.

f. AVOIDANCE OF DEGRADATION: Those familiar with the diamond and gemstone mining industries will recognize that known processes, including laser engraving a mark directly onto the gemstone as taught in U.S. Pat. No. 4,392,476 issued to Gessler, photo-etching of a metallic mark taught in U.S. Pat. No. 4,056,952 issued to Okuda, or ionized-gas etching of a mark taught in U.S. Pat. No. 4,425,769 issued to Hakoune, may be undesirable because engraving may cause part of the diamond to be unusable and may preclude a cut along the desired or optimum crystal plane.

g. FLEXIBILITY: Additionally, such systems should be flexible to account for other types of information that may be associated with a stone. For example, it may be desirable for both gemstone source data and user-specific data to be incorporated into a gemstone code to enable further identification and customization.

Accordingly, there is a need in the art for a better method and apparatus to associate data with gemstones and other objects for identification, tracking, customization, or other purposes at various stages of processing that is fast, inexpensive, flexible, simple to operate and maintain, accepts a wide variety of shapes and sizes of such gemstones and does so without degrading the gemstone.

### SUMMARY OF THE INVENTION

It is an object of this invention to provide a simple, inexpensive method, apparatus and system for marking, identifying, tracking and/or customizing gemstones and other objects using digital identifiers or markings. A digital identifier may indicate, for example, the source of the gemstone (e.g., a mine, country, or trademark),.the chain of custody, grade of the gemstone, or user-specific or customized data such as a wedding date or photograph.

According to one aspect of the invention, objects, such as gemstones, are sorted, weighed and placed within a compartment of a tray. A polymer can be added to each compartment to cover the object and cured with the object encased therein. A laser, ion beam, or other source encodes a digital identifier in the encasement. Once encoded, encased objects with digital identifiers are removed from the trays for further processing.

According to another aspect of the invention, the encased object can take the form of a hemisphere or other predetermined regular geometric shape that permits the location of digital identifier to be readily determined.

Once cured, the encased objects may be separated from the tray and sorted or placed in a transfer system for encoding with a digital identifier such as a matrix. A suitable matrix is taught in U.S. Pat. No. 5,124,536 issued to Priddy, et al., and U.S. Pat. No. 5,773,806 issued to Longacre, Jr., et al.

According to another aspect of the present invention, objects are tracked from a source through various transactions. Source data and transactional data are stored in a database and updated with subsequent transactional data. Upon reaching a cutter or other processing center, an object may be cut into one or more pieces, e.g., into one or more finished gemstones. The cut gemstones are analyzed, and the quality data is transmitted to the database storing source and transactional data. For each of the cut gemstones, the source and transactional data common to the rough gemstone as well as a unique identifier and quality data are encoded into a digital identifier. The digital identifier is applied to each respective finished gemstone.

According to another aspect of the present invention, in addition to encoding source, transactional, and quality data into a digital identifier, a user may provide data, files or information to a cutter or processing center which is also to be included in the same or separate digital identifier. The user data is converted as necessary, and encoded into the digital identifier which is engraved into the gemstone. The user data may be encoded separately or with the source, transactional and quality data.

### BRIEF DESCRIPTION OF THE DRAWINGS

FIGS. 1A-B are illustrations of different configurations of one example digital identifier or digital symbology—a data matrix and a matrix array;

FIG. 2 is a flow diagram illustrating how a matrix is encoded and decoded;

FIG. 3 is a flow diagram of different encoding systems;

FIG. 4 is a display screen illustrating input data represented as a matrix;

FIG. 5 is a display screen illustrating how a matrix can be encoded with a color photograph;

FIG. 6 is a display screen illustrating how a matrix can be encoded with music.

FIGS. 7A-B are display screens illustrating how a matrix can be encoded with a link to a secure website.

FIGS. 8A-B are display screens illustrating how a matrix can be encoded with a link to a secure database.

FIG. 9 is an image of a facet of a gemstone marked with a matrix and other information;

FIG. 10 is a flow diagram of how rough gemstones are processed with a central database and a database system;

FIGS. 11A-E are diagrams illustrating how rough gemstones are encapsulated in tray compartments;

FIGS. 12A-B are diagrams illustrating side and bottom views of an encasement and a gemstone within the encasement;

FIGS. 13A-D is a flow diagram illustrating an alternative technique to coat gemstones;

FIG. 14 is a flow diagram illustrating decoding of a matrix;

FIG. 15 is a flow diagram illustrating which types of data may be stored to a database and encoded into a matrix;

FIG. 16 is a flow diagram illustrating how one or more finished gemstones are cut from a rough gemstone and the

### DETAILED DESCRIPTION

One embodiment of the present invention provides a system for marking objects, such as gemstones, precious metals, and the like, with a digital identifier such as a bar-code or matrix.

Those skilled in the art will recognize and appreciate that the present invention has broad applications to marking various types objects extracted by mining including, but not limited to, gemstones, diamonds, emeralds, rubies, minerals, crystals, ores, pearls, precious metals including platinum, gold, silver, zirconium, copper, durable materials, and other similar materials, either in “rough” or uncut or unprocessed stage or in a cut, processed, finished or polished stage. Further, the present invention has applications to other objects such as watches, jewelry, rare coins, and antiques. However, for purposes of illustration, this explanation refers to marking rough and polished gemstones, with specific examples directed to diamonds. However, these illustrative examples are not intended to limit the present invention.

The present invention may also be utilized with various digital identifiers including a bar-code, a two dimensional bar-code, a matrix, a two dimensional matrix, a three-dimensional matrix, and a matrix array which may include one or multi-dimensional matrices. However, for simplicity, this explanation refers to digital identifiers, with specific examples directed to a matrix. Another aspect of the invention relates to a gemstone identification system based on the marking system. The invention provides a unique and reliable method to identify gemstones with different types of data including source, gemstone quality, transactional, customer, or user-specific data.

Another aspect of the invention relates to a gemstone tracking system based on the above marking and identification systems. The tracking system tracks the history of objects such as gemstones, from, for example, a mine, a point of extraction, or an unprocessed stage to distributors, government agencies, cutters, customers, and other parties.

Digital identifiers such as a matrix may be applied to a gemstone itself or to a material surrounding a gemstone. Following is a detailed description of a matrix and how attributes of the matrix may be utilized to mark, identify, and track gemstones and other objects and materials.

Data Matrix Attributes as Applied to Gemstones

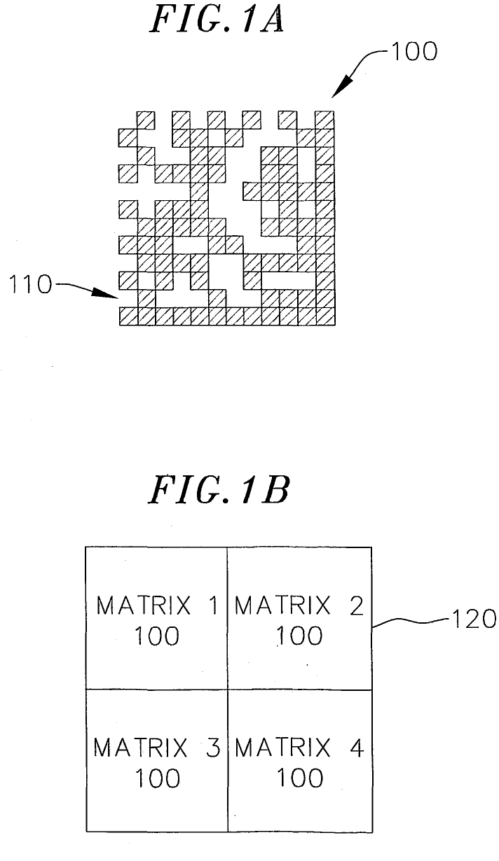

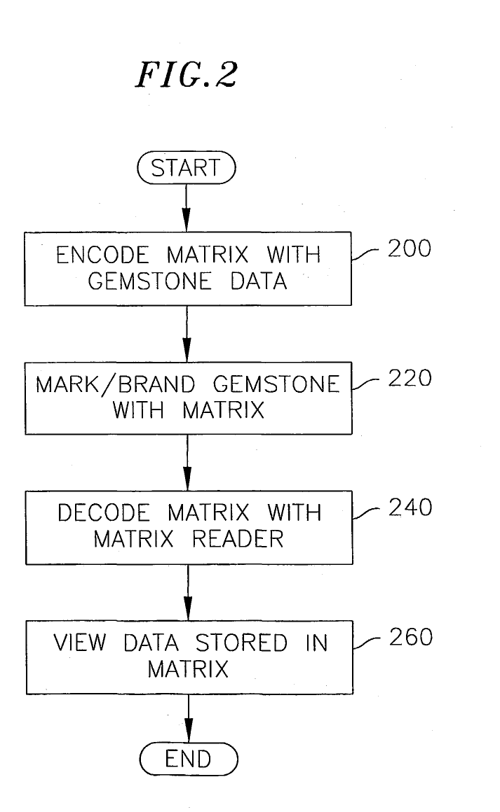

Matrices can represent various types of information using encoded data bits, each of which are stored in a cell of the matrix. With reference to FIG. 1A, atypical matrix 100 includes cells 110 of equal size arranged in a square, e.g., 100×100 cells. Each cell is encoded in a binary manner, e.g., black to designate a “1” or white to designate a “0”. A typical matrix symbol might store between one and 3116 numeric or 2335 alphanumeric characters, thus providing a format to store digital information.

Advantages of using a matrix to store information relating to a gemstone include:

1. Numerous types of stored data. A matrix in a gemstone can be encoded with or serve as an external reference to many different types of data, e.g., text, music, video, audio, color or grayscale photographs, user specific information, or other data representable in digital form. Images and videos can be represented in Moving Picture Experts Group (MPEG) and Joint Photographic Experts Group (JPEG) formats.

2. Broad applications. Matrix data may be utilized for many different purposes. For example, a matrix may relate to identification, inventory control, tracking, storage of user files, or as a link to an external database or website, both of which may be secure given the private nature of gemstone data.

3. Scalability. With reference to FIG. 1B, in the event that larger amounts of information must be stored, individual matrices 100 may be scaled to form an array 120 or collection of matrices. With proper marking, encoding, and decoding devices, a collection of matrices may represent larger amounts of data than individual matrices. Additionally, individual matrices can be encoded in multiple dimensions, e.g., as a two-dimensional matrix or a three-dimensional matrix, to store additional information.

4. Lower Equipment Tolerances. With a matrix, print quality and contrast are less critical than with other identification technologies. As a digital identifier, matrix decoders or readers detect “1s” and “0s”, and thus, determining edge locations or darkness ratios are not necessary. For example, 20% color contrast may be sufficient for matrix decoding. Further, matrices are more tolerant of surface irregularities such as scratches and dust particles.

5. Self Contained Database. Given the data storage capabilities of a matrix, matrix arrays, and multi-dimensional matrices, it may not be necessary to access an external database to obtain the desired information, thus eliminating the need for additional components, computers, networks, and databases.

6. Reference To Dynamic Database. However, data may also be stored to an external dynamic database or website. A matrix can be encoded with information referring to or identifying a file or address within a database or a website address. Thus, instead of reading information directly from a matrix, the information is read from the database or website referenced by the matrix.

7. Size. Matrices are smaller than typical identifiers. Thus, a matrix may be less visible and more easily incorporated into a product such as, for example, into a facet of a gemstone, a graphic, a logo, or a trademark.

8. Flexibility. Matrices may be applied to a variety of flat and curved surfaces. Additionally, a matrix may be read in any orientation (e.g., 360 degree readability), from various distances, and on different materials, e.g., gemstones, precious metals, and polymers. Moreover, matrices can be encoded in any language and store different types of data.

9. Accuracy. Matrices can utilize Reed-Solomon error correction with data redundancy to guarantee a fast and accurate matrix read.

Having described general aspects of a matrix it relates to gemstones, the following describes how a matrix can be incorporated into gemstone marking, identification and tracking systems. Although this system refers to a matrix, those skilled in the art will recognize that other digital identifiers may be utilized.

Referring to FIG. 2, a matrix is encoded with data relating to a gemstone in block 200. in block 220, a gemstone is marked with the encoded matrix. In block 240, a matrix is decoded or read with a matrix reader. After the matrix is decoded, in block 260, the resulting information may be viewed for tracking, inventory, and other purposes. Each of these tasks is explained in further detail below in the context of both rough gemstones and cut gemstones.

Encoding Matrix With Gemstone Data

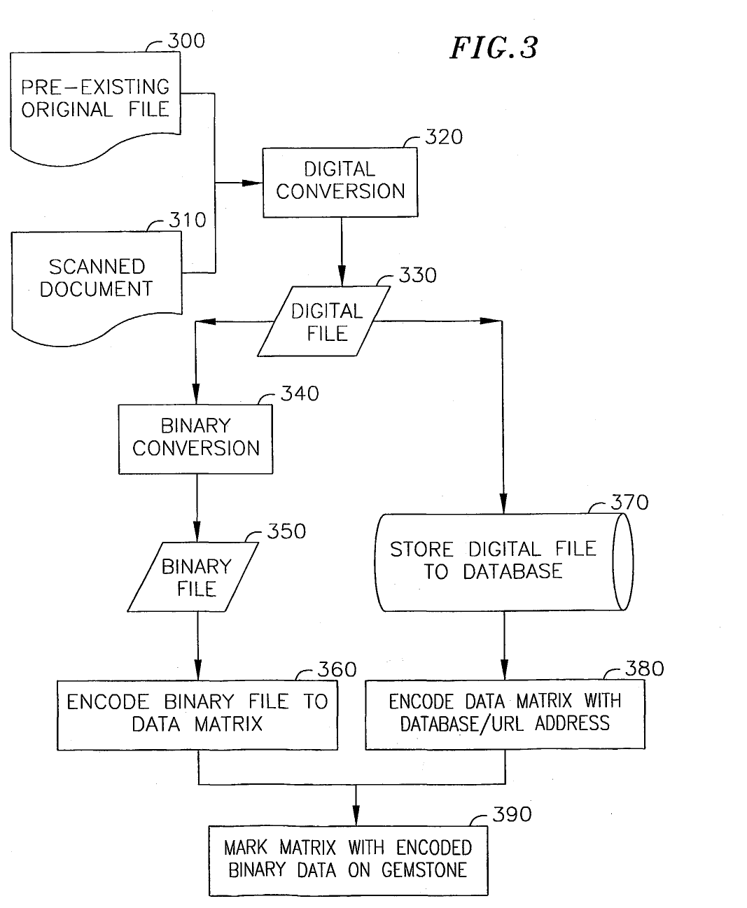

Referring to FIG. 3, a pre-existing original file 300 or a scanned document 310 is processed with digital conversion 320 techniques resulting in a digital file 330. In one encoding format, digital file 330 is further processed with binary conversion 340 resulting in a binary file 350. The digital file 330 can be converted into files of other data formats besides binary 340 including hexadecimal or other common or standard data formats. The binary file is then encoded 360 into a data matrix. Using this system, a matrix may be encoded with or refer to many different types of data, including but not limited to video, image, color or grayscale photographs, audio clips, text, other digital files, or any combination thereof.

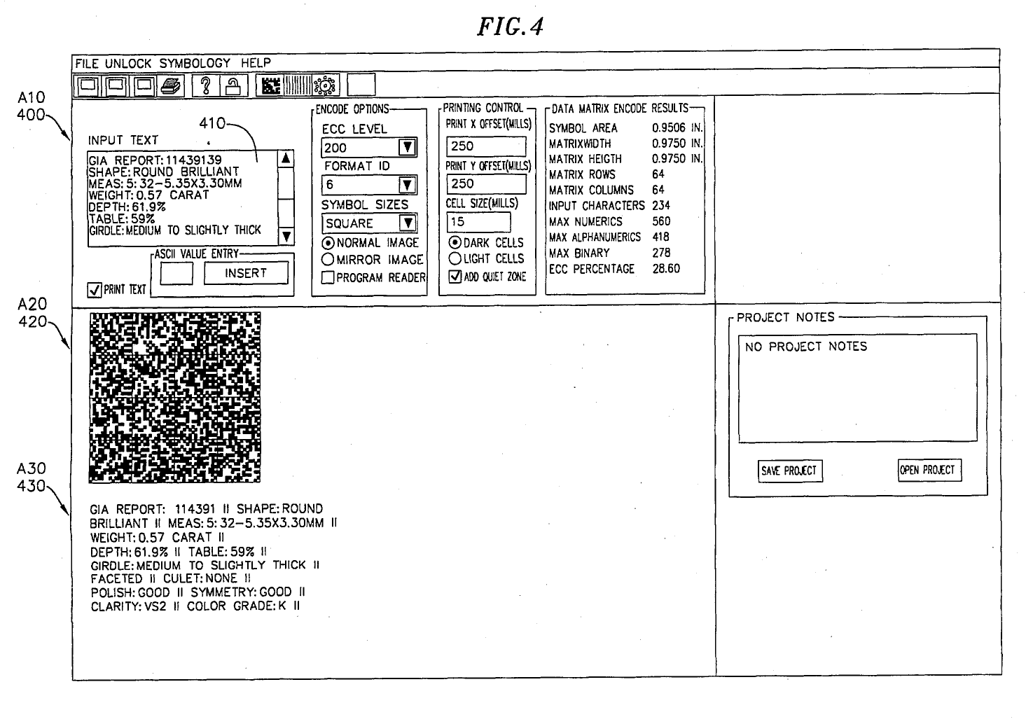

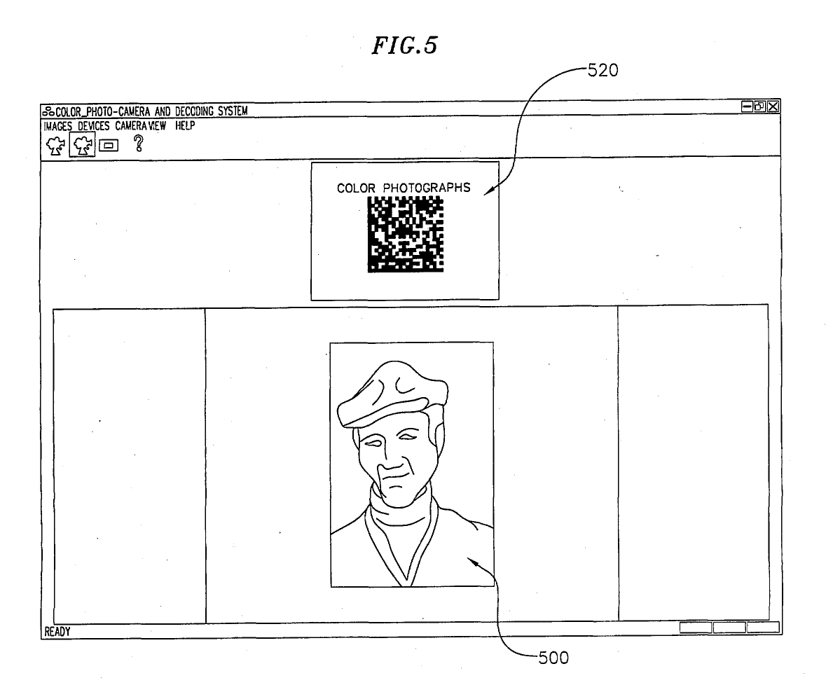

For example, referring to FIG. 4, a user may enter text information 400 into a user input screen 410 to generate a digital representation of that text information. The following data may be entered into the input screen:

GIA Report 11439139

Shape: Round Brilliant

Meas: 5:32-5.35×3.30 mm

Weight: 0.57 carat

Depth: 61.9%

Table: 59%

Girdle: Medium to Slightly Thick

Faceted Culet: None

Polish: Good

Clarity: VS2

Color Grade: K

The “Faceted Culet: None”, “Polish: Good”, “Clarity: VS2”, and “Color Grade: K” are not visible in the illustrated input screen but otherwise are visible by scrolling down. The entered information 400 is represented in digital form as a matrix 420. Below the matrix 420 is the interpretation of the matrix data 430, i.e., the data 400 entered into the input screen 410 by the user.

As another example, a matrix may be encoded with the following data:

Serial No.: 123456789

Source: Ekati Mines

Location: Canada

Date Extracted: Nov. 3, 2000

Weight: 1.26 ct.

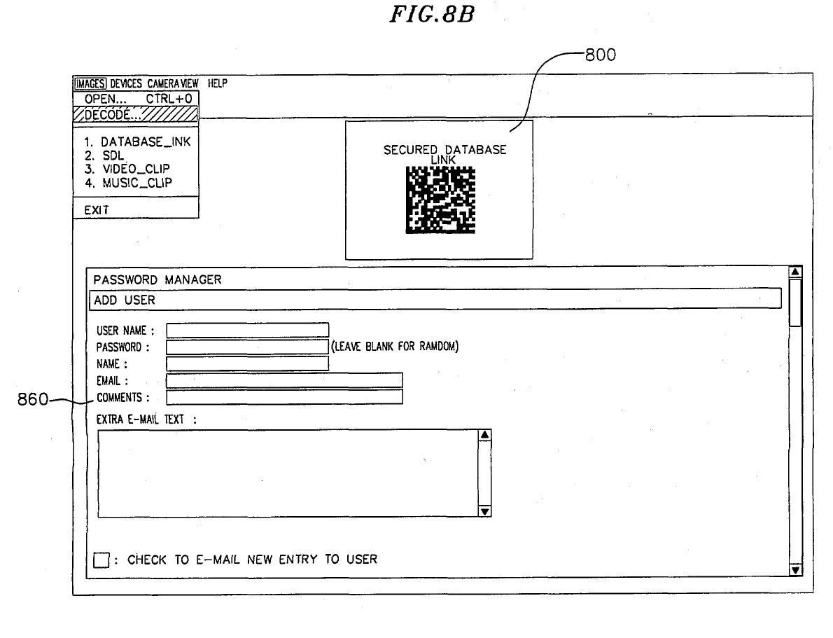

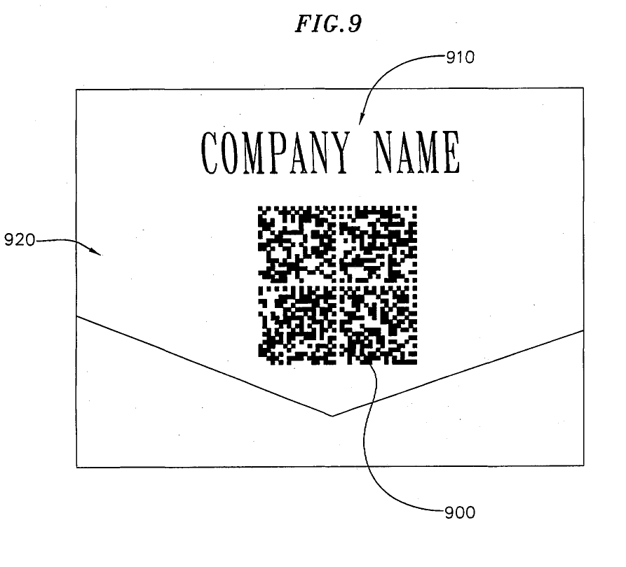

FIGS. 5-10 illustrate further examples of matrix encoding.

Referring to FIG. 5, a user may enter a color photograph 500 (illustrated as grayscale in the photocopy figure) as a Joint Photographic Experts Group (JPEG), Graphics Interchange Format (GIF) or some other common or standard image format. The color photograph is converted into corresponding digital data represented as matrix 520.

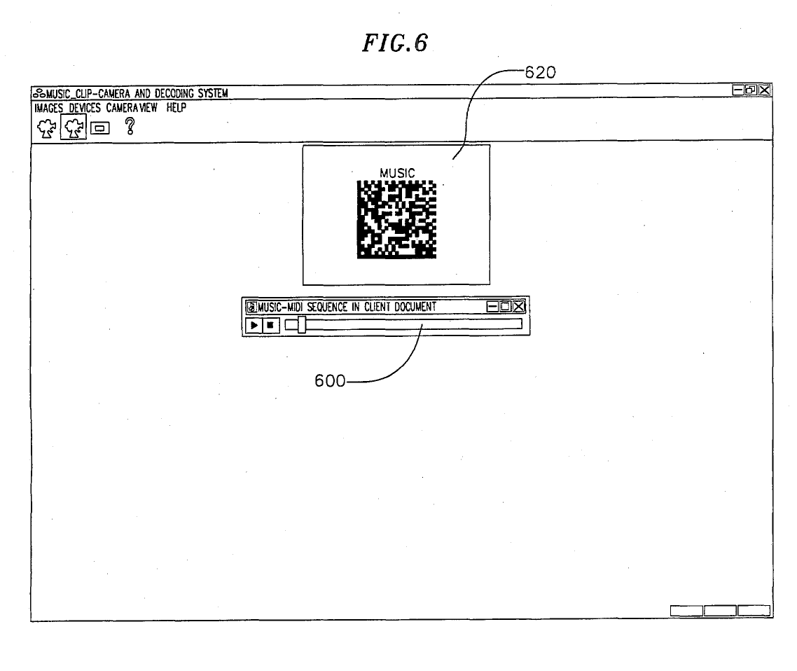

Similarly, referring to FIG. 6, a music file may be entered by user as input 600 in a Musical Instrument Digital Interface (MIDI) format or some other musical format. The music file is converted into a corresponding digital data represented as matrix 620.

Depending on the size of the file or amount of data to be represented as a matrix, the matrix may store the data without the need to access an external database. In other words, the matrix serves as a self-contained database. With matrix arrays or multi-dimensional matrices, larger amounts of information can be stored in a matrix or matrix array as a self-contained database. Alternatively, the matrix may refer or point to an a database, memory address, or website address which stores the gemstone information. Thus, if the storage capabilities of an individual matrix are limited, the information can be stored to an external database, and the matrix can refer to or identify that database.

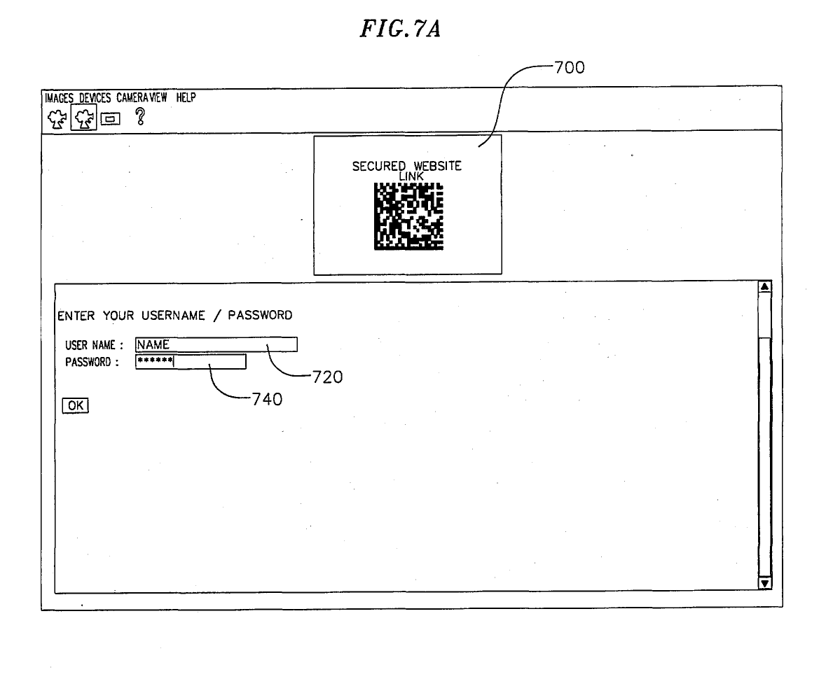

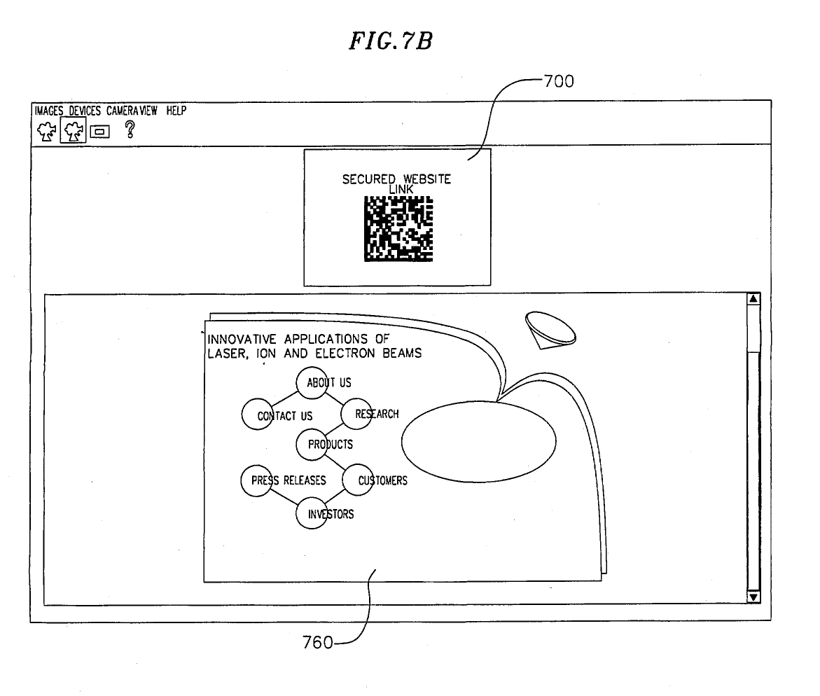

For example, referring to FIG. 7, matrix 700 may represent a link to a website, e.g., the Uniform Resource Locator (URL) address of the website. When the matrix is decoded into the website address, a link to that website identified, and that link may be incorporated into an Internet browser to display the website. The website can be a secure website and is configured to require a user name 720 and password 740 to access the website identified by matrix 700. Referring to FIG. 7B, upon entering the appropriate user name 720 and password 740, the website 760 represented by the matrix is displayed to a user.

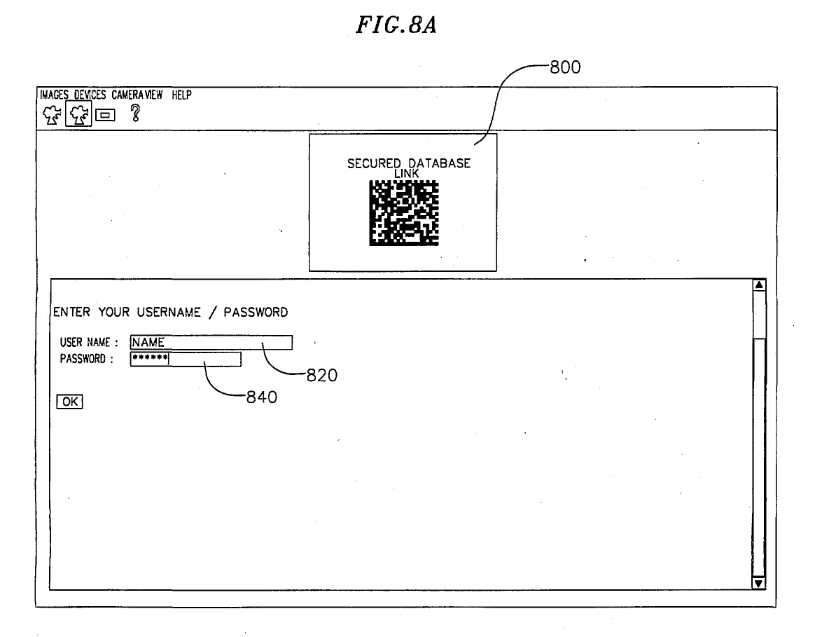

Similarly, a matrix can represent a link to a database or a particular file within a database. In FIG. 8, the database is a secured database and configured to require a user name 820 and password 840 to access the database referenced by the matrix 800. Referring to FIG. 8B, upon entering the appropriate user name 820 and password 840, a user is allowed to access the database 860 referenced by matrix 800.

Techniques For Marking Gemstones With Matrix Data

After encoding the matrix with the desired data, the matrix is marked or branded onto a gemstone. The matrix is applied to the gemstone directly or to a material surrounding the gemstone. For example, a matrix or bar code may be marked or “branded” onto a gemstone directly or applied to an encasement surrounding the gemstone.

Direct Branding a Gemstone With Matrix Data

The matrix 900 and other desired information 910, such as a company name, may be branded onto any part of the gemstone, e.g., a facet 920, table, girdle, or other location. There are many ways to brand a gemstone, some of which are discussed for purposes of illustration. However, those skilled in the art will readily recognize that gemstones may be marked in many different ways.

For example, a focused ion beam may be used to mark a gemstone with a matrix. Depending on the attributes of the focused ion beam, the matrix can range in size from about 50 nanometers to about 1 millimeter. A matrix 900 and other information 910 can also be directly branded onto a gemstone using a laser. With a laser, the matrix 900 size ranges from about 10 micrometers to a few inches. For example, a relatively low-power laser system such as a Nd:YAG may be utilized. Laser coding is suitable for automated or semi-automated encoding and may be accomplished with relatively simple alignment and transport equipment. Additionally, a matrix can be applied directly to a gemstone using various photolithography techniques, electron beams, cathodic bombardment, and other techniques known in the art for branding gemstones.

The previously described marking technologies may be utilized to mark different types of gemstones at different stages of processing or finishing. With diamonds, for example, matrix data may be applied to both rough (i.e., uncut or unpolished) diamonds as extracted from a mine, as well as cut and polished diamonds processed by a diamond cutter. Further, a matrix may be applied to an encapsulated gemstone, i.e., to a material surrounding or encasing the gemstone. For example, instead of branding the matrix 900 directly onto a gemstone, a matrix may also be applied to a parcel, package, or encasement using, for example, a printer. With commercially available printers, matrix sizes range from about a few millimeters to about a few inches.

Following is a more detailed description of how encapsulated rough gemstones can be marked with matrix data. Although the following examples describe the marking of encapsulated rough gemstones, those skilled in the art will recognize that the described processes are also applicable to finished gemstones and gemstones at different stages of processing.

Marking Encapsulated Rough Gemstones With Matrix Data

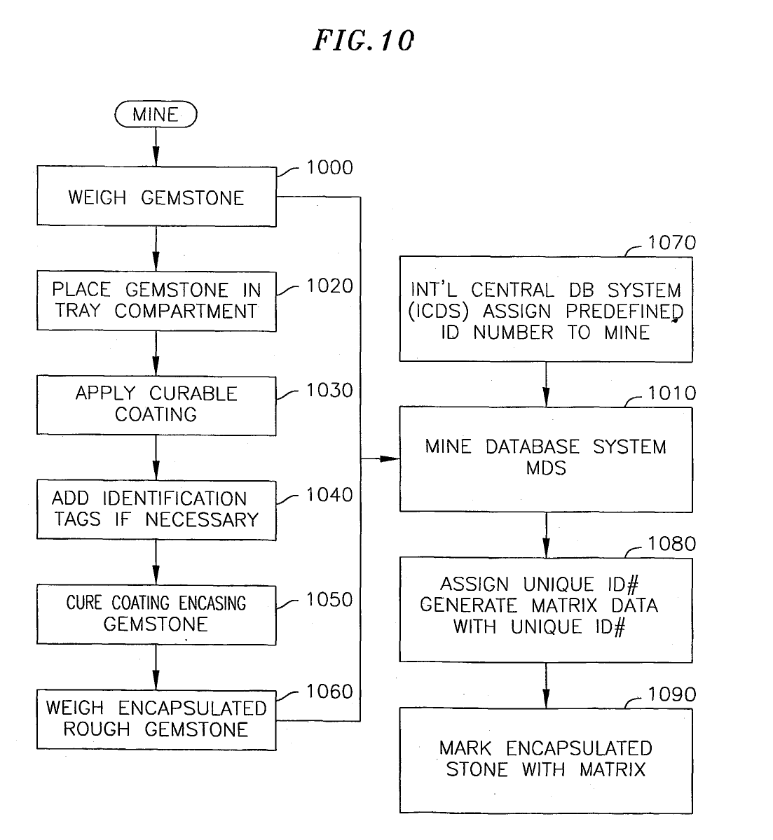

FIG. 10 illustrates the process of encapsulating a gemstone and applying a matrix to the encapsulation material. Initially, gemstones are extracted from a mine. These uncut and unpolished gemstones, i.e., “rough” gemstones, are weighed in step 1000. Data obtained from step 1000 is transmitted to a Mine Database System (MDS) in step 1010. Continuing with step 1020, each gemstone is placed in a compartment of a tray. In step 1030, a curable coating, such as a polymer, is added to each tray compartment holding a gemstone. If desired, in step 1040, microscopic identification tags are added to the polymer. Then, in step 1050, the coating encapsulating the gemstone is cured. In step 1060, a second weight measurement is taken., i.e., of the rough gemstone and the cured coating 1070 and transmitted to MDS 1010.

An International Central Database System (ICDS) assigns a unique identifier, e.g., a unique identification number, to each mine in step 1070. With the unique mine number generated in step 1070 and the weight data from steps 1000 and 1060 by the MDS 1010, a unique identification number for each object is generated in step 1080. The unique identification number generated in step 1080 is incorporated into a data matrix. Then, in step 1090, the encapsulated gemstone is marked with the matrix containing the unique identification information. Alternatively, the rough gemstone may be weighed in step 1000, the weight data reported to MDS in step 1010, and a matrix branded onto the rough gemstone. Thus, continuing one of the previous examples, the matrix may represent the following information:

Serial No.: 123456789

Source: Ekati Mines

Location: Canada

Date Extracted: Nov. 3, 2000

Weight: 1.26 ct. (rough gemstone)

Weight: 4.36 ct. (encapsulated gemstone)

Processing Center: 3Beams Technologies

Having generated the matrix and marked each gemstone with a matrix, the gemstones may be shipped to, for example, government agencies, distributors, cutters, etc. From time to time, as will be explained in further detail below, the ICDS 1100 is updated to reflect changes to gemstone information, e.g., the chain of custody, resulting from gemstone transactions.

Further, those skilled in the art will recognize that parcels or groups of gemstones may be marked with matrix data for transactional, chain of custody or similar purposes. Thus, not only individual marked gemstones can be tracked as previously described, but groups of marked or unmarked gemstones, can also be tracked or processed with one or more matrices.

Additionally, while the previous explanation provides that a matrix is marked at a cutter, the matrix may be applied at any stage by different individuals, parties, agencies, distributors, wholesalers, or service bureaus.

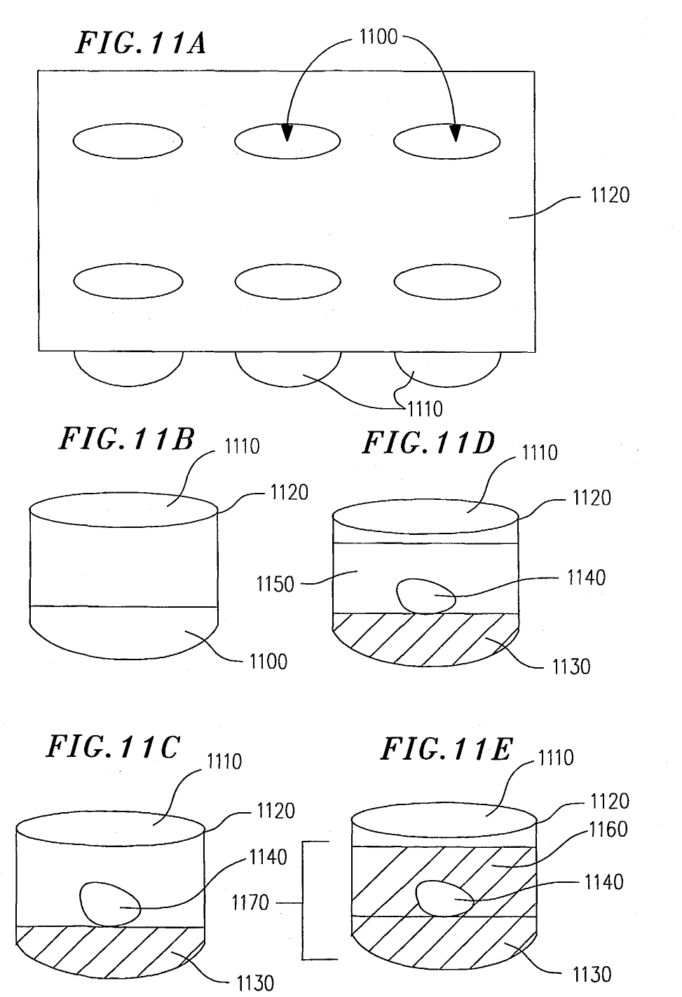

FIG. 11 provides further details of how a matrix is applied to an encapsulated rough gemstone as previously described. Specifically, referring to FIGS. 11A-B, a first encasement material 1100 is provided to compartments 1110 of a tray 1120 into which rough gemstones will be placed. The tray 1120 may be of a size and shape to match a coordinate transfer system, such as a conveyer belt, to facilitate efficient rough gemstone processing from the mine, point of extraction, or distribution point. If necessary, the encasement material 1110 may be transparent or translucent to enable the rough gemstone to be seen through the casing. The first encasement material 1100 is provided to any number of tray compartments 1110, depending on the number of rough gemstones to be processed.

One example of a first encasement material 200 is a curable polymer. One example curable polymer that may be utilized results from a combination of a resin and a curing agent such as a hardener or other curing agent such as heat or ultraviolet light. For example, a resin and a hardener manufactured by Tap Plastics, Incorporated, Dublin, Calif., may be combined to form a curable polymer which forms an encasement. The resin used may be a resin with the product name “Tap Plastics Epoxy Resin” or the common name “general purpose 1:1 epoxy”. The hardener may be a hardener with the product name “Tap Plastics Epoxy Hardener”. The polymer will not degrade the rough gemstone and is added to the tray compartments 210.

Other examples of a first encasement material 1100 include various thermoplastics. Melted or liquid thermoplastic material is injected into or provided to a mold, e.g., compartments 1110 of tray 1120. Many different thermoplastics may be utilized, including but not limited to polyethylene, polybutylene, polycyclohexane, polyphenylene, polycarbonate, polystyrene, polypropylene, polyamide, polyvinylchloride, polyacetal, fluroresins, acrylic resins, and polysulfones, all of which are well known and commercially available from numerous companies.

Curing can also be performed by removing heat or permitting the first encasement material 1100 to cool. For example, when thermoplastics cool, they assume the form and shape of their respective molds or tray compartments 1110. Additionally, the first encasement material 1100 which is cured with radiation or light, e.g., “photo-polymers” cured with infrared (IR), ultraviolet (UV), or other forms of radiation. After curing, the liquid photo-polymer forms a solid polymer. Some of the previously mentioned thermoplastics may be used as a photo-polymer with the addition of a photo-initiator.

Continuing with reference to FIG. 11C, the first encasement material 1100 is cured resulting in a first cured material 1130. Different curing techniques can be utilized depending on the encasement material 1100 chosen. For example, the previously described polymers can be cured with heat, e.g., heated at about 100 degrees Centigrade for about 30 minutes. After curing, the polymer hardens. Of course, different polymers may be cured at different temperatures for different lengths of time.

After the first encasement material 1100 is cured 1130, the rough gemstones 1140 are placed into the compartments 1110. If the cured material 1130 is completely cured and solid, the rough gemstone 1140 rests on top of the cured material 1130. If the cured material 1130 is partially cured, then the rough gemstone 1140 may settle partially into the partially cured material 1130.

After placing rough gemstones 1140 into compartments 1110, in FIG. 11D, a second encasement material 1150 is added to the compartments 1110. The second encasement material 1150 partially or completely fills the remaining space in each compartment 1110. The second encasement material 1150 may be the first encasement materials 1100 previously described.

In FIG. 11E, the second encasement material 1150 is cured, resulting in a second cured material 1160. The second encasement material 1150 may be cured 1160 with the curing techniques described with respect to the first cured material 1130. In each compartment, the first and second cured material sections 1130, 1160 form an encasement 1170 surrounding rough gemstone 1140.

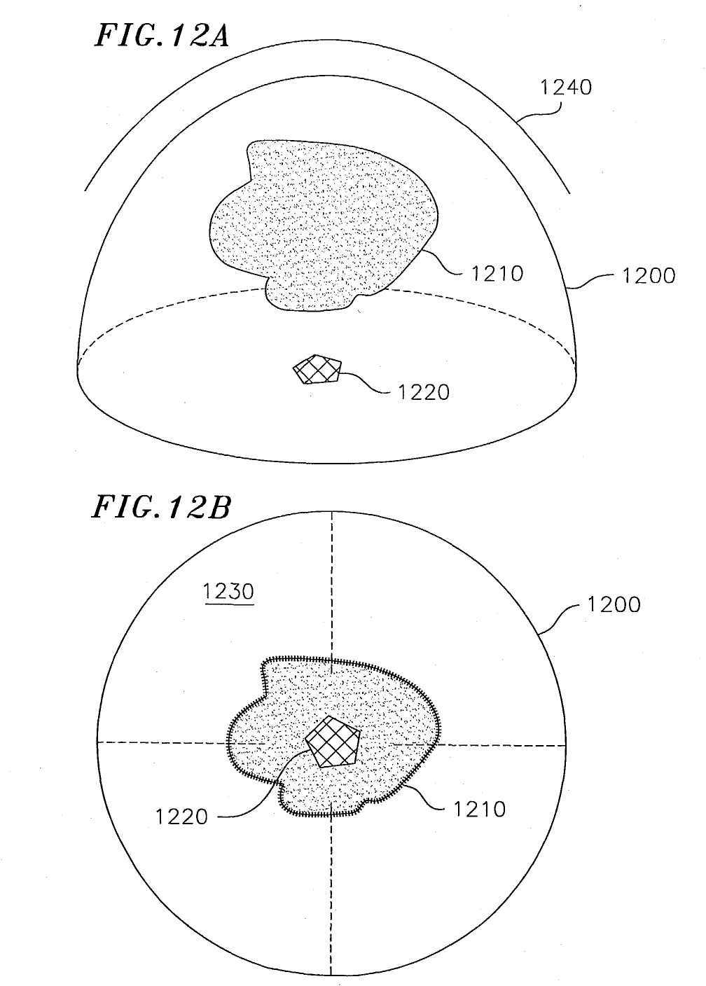

Referring to FIGS. 12A-B, having cured the polymer or encasement 1200, data related to the rough gemstone 1210 may be encoded in a digital identifier 1220 such as a matrix. The digital identifier 1220 is applied to the cured coating 1200 and may be visible to the human eye or microscopic depending on the size of the matrix and matrix encoding and decoding devices utilized. In one embodiment, a matrix 1220 is placed at the center of a round flat surface 1230 of the hemispheric encasement 1240. Placing the matrix 1220 on a predetermined smooth or flat face 1230 of the hemisphere 1240 results in a number of benefits: problems associated with placing a matrix on surface irregularities are eliminated; automation is enabled more easily; identification tags provide security; the polymer is environmentally friendly and will not damage gemstone; the polymer hemisphere serves as a magnifying lens, e.g., 10-50× magnification; and the polymer can withstand high temperature. Other geometric shapes, such as frustoconical configuration, polyconical or pyramidal, may be selected and used for encasement and coding.

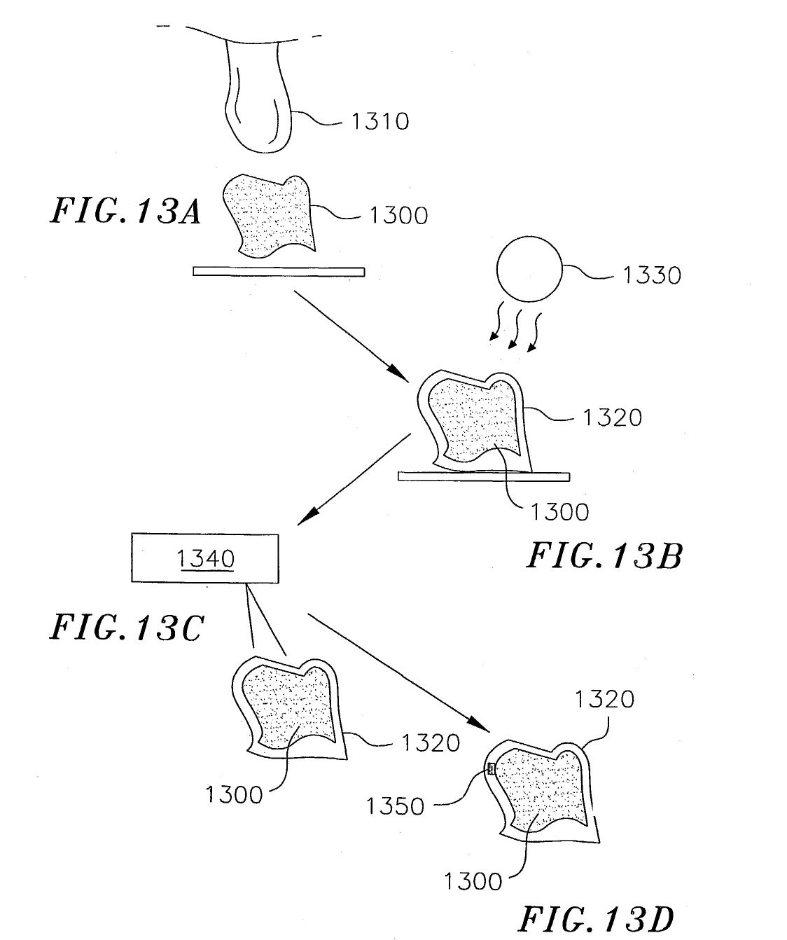

In an alternative embodiment, as illustrated in FIG. 13, rough gemstone 1300 is surface coated with polymer 1310 rather than encapsulated in a hemisphere shape. The outer shape of an encasement 1320 will in turn reflect the topography of the rough gemstone 1300 within. As in the previously described embodiment, the polymer 1310 is cured 1330 and hardened resulting in an encased rough gemstone 1300.

Data to be associated with rough gemstone is selected and encoded 1340 with an encoding device into a digital identifier 1350 such as a matrix. Encoding 1340 may be further enhanced by using a low power focusing laser to target the placement for encoder with, for example, machine vision alignment. Matrix encoding and machine vision alignment is well known in the art and, therefore, a detailed description of the system has been omitted.

Matrix Readers/Decoders

After encoding a matrix and marking the identifier onto a gemstone, the matrix of a gemstone may be decoded 240 or read for various reasons. The flexibility of a matrix to serve as a self-contained database or as a reference to an external data store leads to further flexibility in a reader 150 to decode this data. Thus, a matrix decoder or reader 150 may take many forms. Matrix symbols may be read by readers utilizing Charged Coupled Devices (CCDs), video cameras (images), or display monitors. Various matrix decoders or readers may be utilized, for example, matrix software and viewers from Robotic Vision Systems, Inc. of Canton, Mass. and the Quadrus matrix decoding systems from MicroScan of Renton, Wash. Further, if the matrix is encoded with a file or memory address of a database or an address of a website, that address or website link may be incorporated into a database system or Internet browser to display the requested database or website storing the gemstone data.

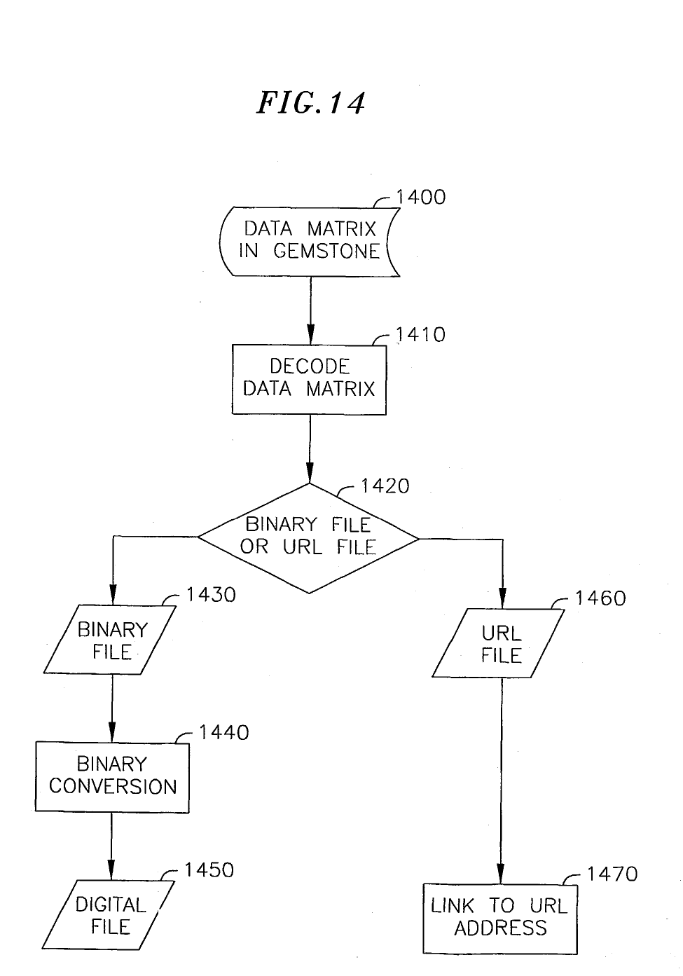

The general decoding process 240 is basically the reverse of the encoding 220 process. With reference to FIG. 14, a data matrix 1400 in a gemstone is decoded 1410 with a matrix reader. The matrix data, in block 1420, may represent a binary file (or a another common or standard data format). The matrix data 1420 may also represent a reference to an external database, e.g., a URL address of a website which contains the requested data or a memory address of an external database. If the matrix is a binary file 1430, then a binary conversion 1440 from binary to a digital format is performed, resulting in a digital file 1450. However, if the matrix is a reference to an external address, e.g., a URL address or file 1460, then the decoding process results in that URL address 1470, and with Internet, network, or database capabilities, a user may be linked to a web site or database which stores the gemstone information.

Rough Gemstone-Reading Matrix

Referring back to FIGS. 12A-B and continuing the illustrative example involving encapsulated rough gemstones, matrix decoding may be enhanced by placing the matrix 1220 at the center of the round flat bottom face 1230 of casing 1200. By placing the matrix 1220 at a known predetermined site on casing 1200, a reader positioned in the general location of the matrix 1220 will be able to read the matrix 1220. Placement of the matrix at the same predetermined coordinates on the same selected region of each similar encasement simplifies the task of locating and reading the matrix, which in turn facilitates automated processing of the encasement. This is particularly useful if the information is recorded in microscopic form and cannot be easily found with the naked eye.

Rough Gemstone-Removing Polymer

After the encased gemstones are processed and their respective information is decoded or read for identification, tracking, chain of custody, user-specific data, or other purposes, the gemstone will eventually be removed from the casing. For example, if the rough gemstone arrives at a diamond processing center, service bureau, distributor, or other processing center, the encasements may be removed such that the rough gemstone can be cut into a number of finished gemstones. In one embodiment, encasements are removed by applying a solvent or stripping agent to the encasement or submerging the encased rough gemstone in the solvent. The solvent should remove or dissolve the encasement material without damaging the gemstone.

One example solvent for decapsulation of gemstone encasements formed by cured epoxy resins is Master Bond MB6A manufactured by Master Bond, Incorporated of Hackensack, N.J. This solvent dissolves the epoxy resin encasement material previously described. For example, a beaker of MB6A is heated to about 100° C., and an encased gemstone is placed in the solvent for about 10 minutes. Thereafter, the encasement will begin to break down and fracture into individual pieces. The solvent, however, should not degrade or damage the gemstone. After all the encasement material is removed from the gemstone, the gemstone is removed from the beaker. If necessary, the diamond may be re-encased at a future time. Indeed, various combinations of encasement materials and solvents may be utilized that do not damage encased gemstones.

Applications

Considering the attributes of matrix symbologies, the ability to incorporate a matrix into gemstone processing, and manner in which matrices may be encoded and decoded, numerous applications relating to marking, identifying, inventory control tracking, and customizing gemstones are realized. Some of the example applications that are realized with matrix technologies are described below.

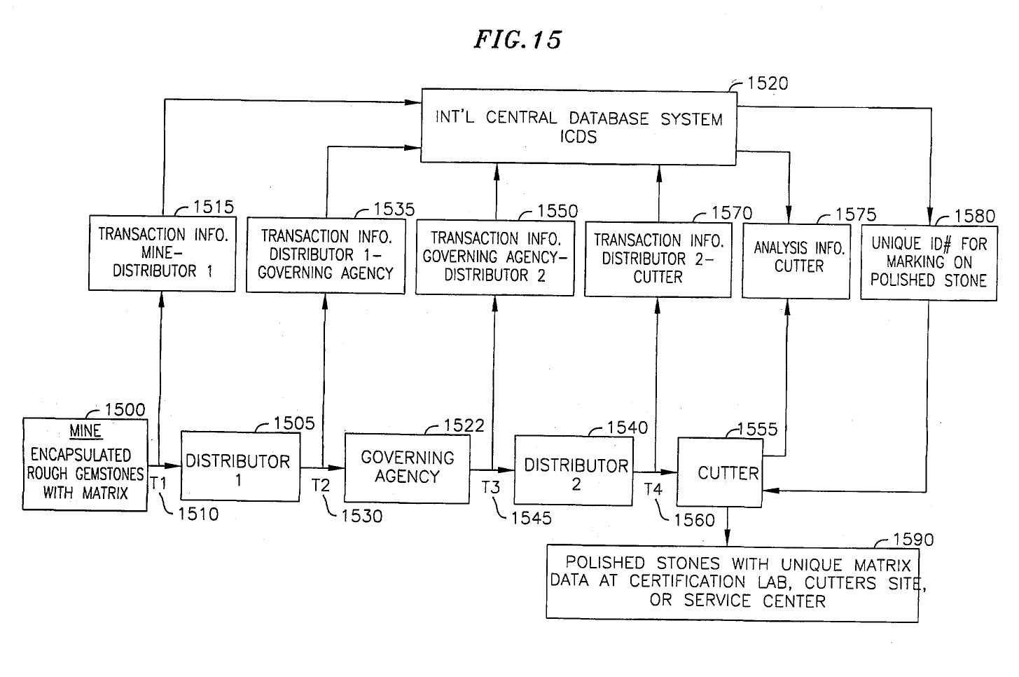

FIG. 15 illustrates one example application of tracking the chain of custody or transaction history of a rough gemstone. A transaction involving a rough or cut gemstone may relate to a transaction may be between a mine and a distributor, a mine and a government agency, a mine and a cutter, a mine and a customer, a distributor and a government agency, a distributor and a cutter, a distributor and a customer, a cutter and a customer, and a first customer and a second customer, a sale of the finished gemstone, a lease of the finished gemstone, a gift of the finished gemstone, a change of ownership of the finished gemstone, a bequest of the finished gemstone, or a devise of the finished gemstone. The same techniques and principles may be applied to other identification and inventory control applications for rough gemstones, polished gemstones, precious metals, and other objects.

Rough Gemstone/Tracking System

Initially, a rough gemstone is extracted from a mine or point of extraction 1500. As previously described with respect to FIG. 10, an initial digital identifier or initial matrix is applied to an encapsulated gemstone or branded directly onto a rough gemstone. The “source” gemstone data encoded in the initial matrix may include the following data:

Unique ID: 123456789

Country of Origin: Canada

Name of Mine: Ekati Mines

Weight: 1.26 ct (Rough Gemstone)

Weight: 4.36 ct (Encapsulated Rough Gemstone)

Excavation Date: Nov. 3, 2000

Additional Text Information: 3Beams Technologies

The encapsulated gemstone encoded with this initial digital identifier may pass from the mine 1500 to a distributor 1 1505 in transaction 1 (T1) 1510. Data 1515 relating to T1 1510 is provided to a central database such as an International Central Database System (ICDS) 1520.

In addition, the gemstone source data encoded in the initial matrix 10 may also be decoded and recorded to the ICDS 1520. Thus, the “history” data of this rough gemstone recorded to the ICDS 1520 may include the source data decoded from the initial matrix and/or data relating to the first transaction. The encapsulated rough gemstone may then pass from distributor 1505 to a governing agency 1525 (e.g., the United Nations) in transaction 2 (T2) 1530. Data 1535 relating to T2 1530 is also provided to ICDS 1520. T2 1530 data may replace or supplement T1 data 1510 to update a data set which stores transactional data in ICDS 1520.

The gemstone may then pass from governing agency 1525 to distributor 2 1540 in transaction 3 (T3) 1545. Data 1550 relating to T3 1545 is provided to ICDS 1520. The T3 data 1550 may replace or supplement the data 1515 and 1535 from T1 1510 and T2 1530.

The gemstone may then pass from Distributor 2 1540 to Cutter 1555 in transaction 4 (T4) 1560. Data 1570 relating to T4 1560 is also provided to ICDS 1520 and may replace or supplement data from the prior three transactions 1510, 1530, 1545.

Thus, a complete transaction history or chain of custody from the mine to different parties is stored in the ICDS 1520. Additionally, source gemstone data decoded from the initial matrix may also stored in the ICDS 1520. As a result, a complete history of a rough gemstone and data relating to the rough gemstone are stored in a central database.

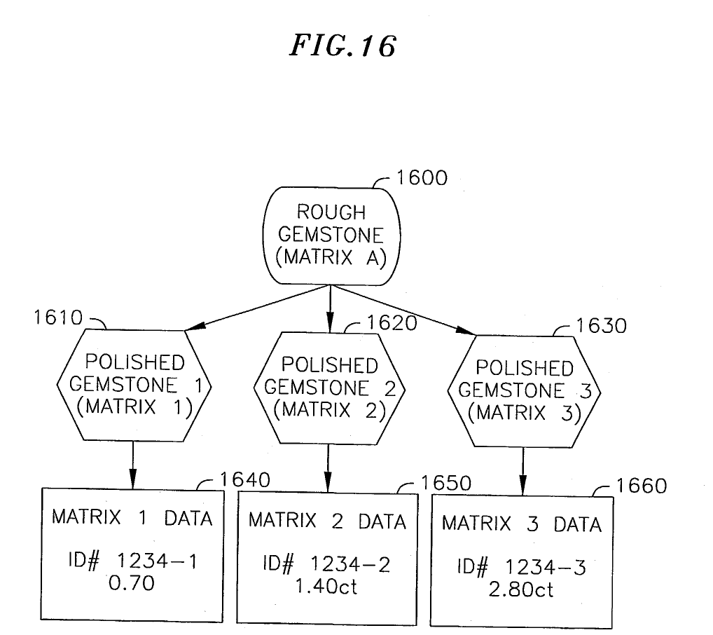

With reference to FIG. 16, a cutter transforms an unfinished, uncut, rough gemstone 1600 into one or more cut and/or polished gemstones 1610, 1620, 1630. Each of the cut gemstones 1610, 1620, 1630 is cut to a particular size, shape and weight. The cutter analyzes quality attributes (e.g., weight, shape, cutting style, measurement, proportion, clarity, and color) of each cut gemstone 1610, 1620, 1630.

For each cut gemstone, the cutter 1555 transmits the quality analysis data 1575 to the ICDS 1520, which may also include the transaction and source data. Additionally, for each cut gemstone, the ICDS 1520 generates a unique identifier 1580.

Referring to FIG. 16, a digital identifier 1640 for the first cut or finished gemstone 1640 is encoded with the unique identifier 1234-1, quality data (e.g., 0.70 carats) of the first finished gemstone, and the transaction history and source data of the parent rough gemstone. Similarly, a digital identifier 1650 for the second finished gemstone 1620 is encoded with unique identifier 1234-2, quality data (e.g., 1.40 carats) of the second finished gemstone, and the transaction history and source data of the parent rough gemstone. A digital identifier 1660 is also cut for the third gemstone 1630. This gemstone 1630 is encoded with a unique identifier 1234-3, quality data (e.g., 2.80 carats) of the third finished gemstone, and the transaction history and source data of the parent rough gemstone.

Referring again to FIG. 15, these unique matrix codes, one for each of the three cut gemstones are transmitted 1580 to a cutter 1555. Each matrix is encoded with the respective data by the cutter. As a result, each gemstone cut from a common rough gemstone can be encoded with the same source and transactional data, but has unique digital identifiers and quality data. Of course, a matrix may be encoded with only source, transactional, or quality data, or any combination thereof depending on the particular needs of an owner or party.

Further, although the current example illustrates a series of rough diamond exchanges ending with a cutter applying a matrix to three finished gemstones, the matrix may be applied at different stages of processing by different parties and in rough or finished form. For example, the matrix can be applied by distributor 1 1505, a governing agency 1522, distributor 2 1540, or anyone else who is involved in diamond processing, including but not limited to a service center, certification laboratory, or other processing or servicing location.

Gemstone Customization

In addition, a matrix can be encoded with owner-specific or customized information. Considering the flexibility of a matrix to serve as a self-contained database or a reference to an external database, gemstone owners have a broad range of options when personalizing a gemstone with different types of data.

An owner may have a gemstone customized with user-specific video clips, images, color or grayscale photographs, audio clips, text, or any combination thereof. As an example, an owner can arrange for a matrix to be encoded with a wedding photograph on a wedding ring. Thus, not only does a ring serve as a token of marriage, it is further enhanced with additional marriage memories, as well as other data if desired (e.g., transactional data, source data, and quality data).

The owner-specific data can be encoded in the same matrix as the transaction, source, and/or quality data, depending on the size of the matrix and content or amount of owner-specific data. Of course, all or a portion of the data may be stored in a single matrix, a matrix array, or a multi-dimensional matrix. Further, the owner-specific data may be stored to a database or website referenced by a matrix in which case the matrix is encoded with a memory or website address as previously described. The owner-specific data may be encoded into the same matrix as other gemstone information or into a separate matrix which is also applied to the gemstone. In this embodiment, the first matrix may include the original information such as transaction, source and quality data. The second matrix may include the user data e.g., a wedding photograph or video. Further, subsequent new data may be encoded in a different matrix which is later applied to the gemstone. Thus, a gemstone may be branded with multiple matrices. Thus, when one matrix is scanned, the transactional, source, and/or quality data may appear. When a different matrix is scanned, the wedding photographs or video may appear. The options for encoding user-specific data are described in further detail below.

If the owner data is known when a matrix is initially branded onto a gemstone, the matrix may be encoded with the desired data such as a video, image, or audio file, together with any transaction, source, or quality data as necessary. With this direct system, the user data may be encoded into the matrix at various times. For example, a wedding photograph may be submitted to a cutter 1110 or service bureau. When the cutter 1110 cuts the gemstone to the specified criteria and gathers quality data about the gemstone, the cutter may encode quality data, history or transactional data, and the wedding photograph, into a matrix. Alternatively, an owner may bring the gemstone to a service bureau or other gemstone processing center to have the data encoded into a matrix and have the matrix applied to the gemstone. Thus, when a diamond ring and the corresponding matrix or matrices are scanned, the image of the wedding photograph is decoded and displayed, in addition to any transactional, source, and quality information if available. If the user data is a photograph for example, a separate application such as a JPEG viewer may be launched to view the photograph separately from the other data.

In an alternative embodiment, instead of encoding user data into a matrix, user data may be stored to an external database. The user data is referenced by an identifier, e.g., a unique numeric identifier, a memory address, or file pointer encoded within the existing matrix. When the matrix is decoded into the memory or file address, a link to the database is established and the owner-specific information is displayed. Using a reference to an external database provides the ability to “store” or an reference an amount of information limited only by available space or memory. Of course, the address of the external database storing the user data may be encoded into a second matrix, and the second matrix may be branded to the gemstone.

In an alternative embodiment, owner-specific data can be loaded into a website, and the matrix can be decoded to link to the web page. When the matrix is decoded into the website address, a link to that website identified, and that link may be incorporated into an Internet browser to display the website. In addition to linking to a website, the decoded matrix may also provide any other encoded data, e.g., transaction or source data. Using a website reference provides the ability to “store” a larger amount of information. Of course, the web address of the web site storing the user data may be encoded into a second matrix, and the second matrix may be branded to the gemstone.

With these systems, many different types of data may be encoded into a matrix or stored in a dynamic database and accessed via the matrix which stored encoded memory addresses or website addresses. Thus, the a matrix effectively serves as a CD-ROM or other similar digital storage device.

In addition, encoding or associating owner-specific information with a gemstone provides further security and anti-counterfeiting safeguards. In the event the gemstone or article of jewelry is ever stolen, a potential buyer, law officer, or insurance agent can scan the jewelry object, decode a matrix,, and retrieve owner-specific information, e.g., a photograph, name, address, telephone number, etc. The jewelry object can then be returned to its rightful owner. Further, if the diamond or jewelry object is transferred in a transaction, the new owner information may be updated and represented in a new matrix which is applied to the gemstone. The updated information may include, for example, a photograph or name of the new owner. Updates may also be performed by loading a photograph of the new owner to an external database or website which stores the original set of information referenced by the matrix. The new photograph may replace or supplement the original owner information.

Conclusion

The present invention provides the ability to identify and track individual gemstones and other objects from the point of extraction to a customer. The customer may also customize the gemstone with specific data. Additionally, the present invention deters counterfeiting and other types of fraud. The present invention enables customers to quickly obtain a complete history of an object such as a gemstone, whether it is rough and uncut or polished. These advantages are realized by storing the necessary information within a digital identifier such as a matrix or within an external database referenced by the matrix. The methods and articles described herein need not be limited to gemstone applications. Other objects and materials such as ores, semi-precious stones, minerals and crystals, and other durable materials could benefit from the identification and security provided by the within invention.

Certain presently preferred embodiments of apparatus and methods for practicing the invention have been described herein in some detail and some potential modifications and additions have been suggested. Other modifications, improvements and additions not described in this document may also be made without departing from the principles of the invention.

What is claimed is:

1. A method of tracking a rough mined object, comprising:
storing data relating to a history of the rough mined object to a data store;
encoding the history data in the data store into a unique digital identifier; and
marking the rough mined object with the encoded unique digital identifier.

2. The method of claim 1, wherein the step of encoding data relating to the history of the rough mined object further comprises encoding data relating to a source of the rough mined object, the source data selected from the group comprising: an identification number, a mine name, a mine location, an extraction date, a weight of the rough mined object, a weight of an encapsulated rough mined object, and a processing center.

3. The method of claim 1, wherein the step of encoding data relating to the history of the rough mined object further comprises encoding data relating to a transaction involving the rough mined object.

4. The method of claim 3, wherein the step of encoding data relating to the transaction further comprises encoding data relating to a transaction between a mine and a distributor.

5. The method of claim 3, wherein the step of encoding data relating to the transaction further comprises encoding data relating to a transaction between a mine and a government agency.

6. The method of claim 3, wherein the step of encoding data relating to the transaction further comprises encoding data relating to a transaction between a mine and a cutter.

7. The method of claim 3, wherein the step of encoding data relating to the transaction further comprises encoding data relating to a-transaction between a mine and a customer.

8. The method of claim 3, wherein the step of encoding data relating to the transaction further comprises encoding data relating to a transaction between a distributor and a government agency.

9. The method of claim 3, wherein the step of encoding data relating to the transaction further comprises encoding data relating to a transaction between a distributor and a cutter.

10. The method of claim 3, wherein the step of encoding data relating to the transaction further comprises encoding data relating to a transaction between a distributor and a customer.

11. The method of claim 3, wherein the step of encoding data relating to the transaction further comprises encoding data relating to a transaction between a cutter and a customer.

12. The method of claim 3, wherein the step of encoding data relating to the transaction further comprises encoding data relating to a transaction between a first customer and a second customer.

13. The method of claim 3, wherein the step of encoding data relating to the transaction further comprises encoding data relating to a transaction selected from the group comprising: a sale; a lease; a gift; a change of ownership; a bequest; and a devise.

14. The method of claim 3, further comprising the steps of:
receiving data relating to a subsequent transaction involving the rough mined object; and
storing the subsequent transaction data to the data store.

15. The method of claim 14, further comprising the steps of:
updating the first transaction data with the subsequent transaction data,
wherein the first and second transaction data in the data store are encoded into the unique digital identifier.

16. The method of claim 14, further comprising the steps of:
encoding the second transaction data in the data store into a second unique digital identifier; and
marking the rough mined object with the encoded second unique digital identifier.

17. The method of claim 1, wherein the unique digital identifier is selected from the group comprising: a bar-code; a two dimensional bar-code; a matrix; a two-dimensional matrix; a three-dimensional matrix; and a matrix array.

18. The method of claim 1, wherein the step of encoding data relating to a history of the rough mined object into the unique digital identifier further comprises the steps of:
converting the history data into a digital file;
formatting the digital file into a standard data format; and
converting the standard format data into the unique digital identifier.

19. The method of claim 18, wherein the step of formatting the digital file into the standard data format further comprises formatting the digital file into binary or hexadecimal data formats.

20. The method of claim 18, wherein the step of converting the history data into the digital file further comprises converting data in a pre-existing file or scanned document into the digital file.

21. The method of claim 1, wherein the step of encoding further comprises the steps of:
converting the history data into a digital file; and
storing the digital file to a data store,
wherein the unique digital identifier is encoded with an address of the digital file in the data store.

22. The method of claim 1, wherein the step of marking the rough mined object with the encoded unique digital identifier further comprises marking the rough mined object with a marking device selected from the group comprising: a laser; photolithography; an electron beam; cathodic bombardment; and a printer.

23. The method of claim 1, further comprising the step of decoding the unique digital identifier into the history data.

24. The method of claim 23, wherein the step of decoding further comprises the steps of:
converting the unique digital identifier into a standard data format; and
converting the standard data format into the digital file.

25. The method of claim 24, wherein the step of decoding the digital file into the standard data format further comprises decoding the digital file into binary or hexadecimal data formats.

26. The method of claim 23, wherein the step of decoding further comprises the steps of:
converting the unique digital identifier into a website address; and
accessing the website referenced by the website address.

27. The method of claim 26, wherein the website comprises a secure website.

28. The method of claim 25, wherein the step of decoding further comprises the steps of:
converting the unique digital identifier into a memory address within an external database; and
accessing the external database referenced by the memory address.

29. The method of claim 28, wherein the database comprises a secure database.

30. The method of claim 1, wherein the unique digital identifier comprises a matrix, the matrix being a self-contained database.

31. The method of claim 1, wherein the unique digital identifier comprises a matrix, and wherein a plurality of matrices represent the history data of the rough mined object.

32. The method of claim 1, wherein the rough mined object is selected from the group comprising a gemstone, a precious metal, gold, platinum, silver, copper, an ore, a diamond, a ruby, a sapphire, a pearl, a mineral, and a crystal.

33. The method of claim 1, before encoding the unique digital identifier, further comprising the step of encapsulating the rough mined object within an encasement, wherein the unique digital identifier is applied to the encasement surrounding the rough mined object.

34. The method of claim 1, wherein the unique digital identifier is branded directly onto the rough mined object.

35. A method of tracking a finished mined object, comprising the steps of:
processing a rough mined object into one or more finished mined objects;
for each of the finished mined objects,
storing data relating to a history of the rough mined object from which the finished mined object was cut to a data store;
encoding the history data in the data store into a unique digital identifier, and
marking the finished mined object with the unique digital identifier.

36. The method of claim 35, wherein the step of encoding data relating to the history of the rough mined object further comprises encoding data relating to a source of a rough mined object from which the finished mined object was cut, the source data selected from the group comprising: an identification number, a mine name, a mine location, an extraction date, a weight of the rough mined object, a weight of an encapsulated rough mined object, and a processing center.

37. The method of claim 35, wherein the step of encoding data relating to the history of the rough mined object further comprises encoding data relating to a transaction involving the rough mined object.

38. The method of claim 37, wherein the step of encoding data relating to the transaction further comprises encoding data relating to a transaction between a mine and a distributor.

39. The method of claim 37, wherein the step of encoding data relating to the transaction further comprises encoding data relating to a transaction between a mine and a government agency.

40. The method of claim 37, wherein the step of encoding data relating to the transaction further comprises encoding data relating to a transaction between a mine and a cutter.

41. The method of claim 37, wherein the step of encoding data relating to the transaction further comprises encoding data relating to a transaction between a mine and a customer.

42. The method of claim 37, wherein the step of encoding data relating to the transaction further comprises encoding data relating to a transaction between a distributor and a government agency.

43. The method of claim 37, wherein the step of encoding data relating to the transaction further comprises encoding data relating to a transaction between a distributor and a cutter.

44. The method of claim 37, wherein the step of encoding data relating to the transaction further comprises encoding data relating to a transaction between a distributor and a customer.

45. The method of claim 37, wherein the step of encoding data relating to the transaction further comprises encoding data relating to a transaction between a cutter and a customer.

46. The method of claim 37, wherein the step of encoding data relating to the transaction further comprises encoding data relating to a transaction between a first customer and a second customer.

47. The method of claim 37, wherein the step of encoding data relating to the transaction further comprises encoding data relating to a transaction selected from the group comprising: a sale; a lease; a gift; a change of ownership; a bequest; and a devise.

48. The method of claim 37, further comprising the steps of:
receiving data relating to a subsequent transaction involving the rough mined object; and
storing the subsequent transaction data to the data store.

49. The method of claim 48, further comprising the step of updating the first transaction data with the subsequent transaction data, wherein the first and second transaction data in the data store is encoded into the unique digital identifier.

50. The method of claim 48, further comprising the steps of:
encoding the subsequent transaction data in the data store into a second unique digital identifier; and
marking the finished mined object with the encoded second unique digital identifier.

51. The method of claim 35, wherein the unique digital identifier is selected from the group comprising: a bar-code; a two dimensional bar-code; a matrix; a two dimensional matrix; a three-dimensional matrix; and a matrix array.

52. The method of claim 3 5, wherein the step of encoding data relating to the history of the rough mined object into the unique digital identifier further comprises the steps of:
converting the history data into a digital file;
formatting the digital file into a standard data format; and
converting the standard format data into the unique digital identifier.

53. The method of claim 52, wherein the step of formatting the digital file into the standard data format further comprises formatting the digital file into binary or hexadecimal data formats.

54. The method of claim 52, wherein the step of converting the history data into the digital file further comprises converting data in a pre-existing file or scanned document into the digital file.

55. The method of claim 35, wherein the step of encoding further comprises the steps of:
converting the history data into a digital file; and
storing the digital file to a data store,
wherein the unique digital identifier is encoded with an address of the digital file in the data store.

56. The method of claim 35, wherein the step of marking the finished mined object with the encoded unique digital identifier further comprises marking the finished mined object with a marking device selected from the group comprising: a focused ion beam; a laser; photolithography; an electron beam; cathodic bombardment; and a printer.

57. The method of claim 35, further comprising the step of decoding the unique digital identifier into the data relating to the history of the rough mined object.

58. The method of claim 57, wherein the step of decoding further comprises the steps of:
converting the unique digital identifier into a standard data format; and
converting the standard data format into the digital file.

59. The method of claim 58, wherein the step of decoding the digital file into the standard data format further comprises decoding the digital file into binary or hexadecimal data formats.

60. The method of claim 59, wherein the step of decoding further comprises the steps of:
converting the unique digital identifier into a website address; and
accessing the website referenced by the website address.

61. The method of claim 60, wherein the website comprises a secure website.

62. The method of claim 58, wherein the step of decoding further comprises the steps of:
converting the unique digital identifier into a memory address within a database; and
accessing the database referenced by the memory address.

63. The method of claim 63, wherein the database comprises a secure database.

64. The method of claim 1, wherein the unique digital identifier comprises a matrix, the matrix being a self-contained database.

65. The method of claim 1, wherein the unique digital identifier comprises a matrix, and wherein the step of encoding further comprises encoding the matrix as a link to an external database.

66. The method of claim 35, wherein the unique digital identifier comprises a matrix, and wherein a plurality of matrices represent the data relating to the history of the rough mined object.

67. The method of claim 35, wherein the finished mined object is selected from the group comprising a gemstone, a polished gemstone, a precious metal, gold, platinum, silver, copper, an ore, a diamond, a ruby, a sapphire, a pearl, a mineral, and a crystal.

68. The method of claim 35, before the step of encoding the history data in the data store into a unique digital identifier, further comprising the steps of:
analyzing the quality of the finished mined object; and
storing the quality data to the data store,

69. The method of claim 68, where the unique digital identifier is encoded with the quality data.

70. The method of claim 68, further comprising the steps of:
encoding the quality data in the data store into a second unique digital identifier; and
marking the finished mined object with the encoded second unique digital identifier.

71. The method of claim 68, wherein the step of analyzing the quality attributes of the finished mined object further comprises analyzing a quality attribute selected from the group comprising: a weight; a shape; a cutting style; a measurement; a proportion; a clarity; and a color.

72. The method of claim 35, wherein marking the finished mined object further comprises marking the unique digital identifier within a logo, graphic, or trademark of the finished mined object.

73. The method of claim 35, wherein marking the finished mined object further comprises marking the unique digital identifier within a facet of the finished mined object.

74. A method of associating owner-specific information with a finished gemstone cut from a rough gemstone, comprising the steps of:
processing the rough gemstone into one or more finished gemstones;
for each of the finished gemstones,
storing owner-specific data to a data store;
encoding the owner-specific data in the data store into a unique digital identifier; and marking the finished gemstone with the encoded unique digital identifier.

75. The method of claim 74, wherein the step of storing owner-specific data to the data store further comprises storing data selected from the group comprising: a video file; an audio file; an image file; a photograph; a text entry; and a number.

76. A method of identifying an object extracted by mining, comprising the steps of:
encoding source and transaction data relating to the mined object data into a data matrix with a data matrix encoder, wherein the data matrix encoder
converts a set of data related to the mined object into a digital file, and
converts the digital file into data represented by the data matrix;
applying the data matrix to the mined object; and
decoding the data matrix with a data matrix reader, wherein the data matrix reader
converts the data matrix data into a digital file, and
converts the digital file into the data relating to the mined object.

77. The method of claim 76, further comprising the step of encoding owner-specific data into the data matrix.

78. A system for reading data encoded in a mined object, comprising:
a database network configured to store data relating to the mined object;
an encoder configured to represent the mined object data stored in the database network as a matrix;
a marking device configured to apply the matrix generated by the encoded to the mined object; and
a decoder configured to read the matrix which references the mined object data in the database network.

79. The system of claim 78, wherein the mined object data comprises source data selected from the group comprising: an identification number, a mine name, a mine location, an extraction date, a weight of a rough mined object, a weight of an encapsulated mined object, and a processing center.

80. The system of claim 78, wherein the mined object data comprises transaction data, the transaction data selected from the group comprising: a transaction between a mine and a distributor, a transaction between a mine and a government agency, a transaction between a mine and a cutter, a transaction between a mine and a customer, a transaction between a distributor and a government agency, a transaction between a distributor and a cutter, a transaction between a distributor and a customer, a transaction between a cutter and a customer, a transaction between a first customer and a second customer, a sale, a lease, a gift, a change of ownership, a bequest, and a devise.

81. The system of claim 78, wherein the mined object data comprises quality data selected from the group comprising: a weight, a shape, a cutting style, a measurement, a proportion, a clarity, and a color.

82. The system of claim 78, wherein the mined object data comprises owner-specific data selected from the group comprising: a video file, an audio file, an image file, a photograph, a text entry, and a number.

83. A database network for managing data relating to mined objects, comprising:
a central database configured to store data relating to the mined object, wherein the central database allocates a unique identifier to the stored data,
the unique identifier and the data relating to the mined object being encoded into a matrix, and the matrix being applied to the mined object.

84. The database network of claim 83, wherein the data relating to the mined object comprises source data, the source data selected from the group comprising: an identification number, a mine name, a mine location, an extraction date, a weight of a rough mined object, a weight of an encapsulated mined object, and a processing center.

85. The database system of claim 83, wherein the data relating to the mined object comprises transaction data, the transaction data selected from the group comprising: a transaction between a mine and a distributor, a transaction between a mine and a government agency, a transaction between a mine and a cutter, a transaction between a mine and a customer, a transaction between a distributor and a government agency, a transaction between a distributor and a cutter, a transaction between a distributor and a customer, a transaction between a cutter and a customer, a transaction between a first customer and a second customer, a sale, a lease, a gift, a change of ownership, a bequest, and a devise.

86. The database network of claim 83, wherein the data relating to the mined object comprises quality data, the quality data selected from the group comprising: a weight, a shape, a cutting style, a measurement, a proportion, a clarity, and a color.

87. The database system of claim 83, wherein the data relating to the mined object comprises owner-specific data, the owner-specific data selected from the group comprising: a video file, an audio file, an image file, a photograph, a text entry, and a number.

88. The method of claim 83, wherein the mined object is selected from the group comprising a gemstone, a rough gemstone, a finished gemstone, a precious metal, gold, platinum, silver, copper, an ore, a diamond, a ruby, a sapphire, a pearl, a mineral, and a crystal.
